(19) United States
(12) Patent Application Publication
(10) Pub. No.: US 2007/0099469 A1
(43) Pub. Date: May 3, 2007

(54) General purpose magnetic connector

(75) Inventor: Joseph Sorensen, Bozeman, MT (US)

Correspondence Address: PATTON BOGGS, 1660 LINCOLN ST, SUITE 2050, DENVER, CO, 80264, US

(73) Assignee: Nite Ize, Inc., Boulder, CO (US)

(21) Appl. No.: 11/592,279

(22) Filed: Nov. 2, 2006

Related U.S. Application Data
(60) Provisional application No. 60/732,905, filed on Nov. 3, 2005.

(51) Int. Cl. H01R 13/28

(52) U.S. Cl. 439/289

(57) ABSTRACT

A general purpose releasable connector comprising: a first connector part comprising: a head, a neck, and a first attachment member, the neck joining the head to the attachment member, the head having a width that is wider than the neck in at least one dimension; a second connector part comprising: a socket for receiving the head and a second attachment member; the socket having a first open end, a base, and a socket wall having opposing sides, the first open end being wider than the head and the base being sufficiently closed to support the head without the head passing through it, the opposing sides sloping inward from the first open end, the socket further including a slot passing through the socket wall, the slot being wider than the neck but narrower than the head; and a first magnet embedded in one of either the head or the socket base, the other of the head or socket base either being ferromagnetic or including a second magnet, or both, whereby when the head is placed in the socket, the head is automatically guided into and magnetically held in the socket. A logo is attached to one of said connector to make an advertising give-away or a personalized gift.

### RELATED APPLICATIONS

This application claims the benefit of U.S. Provisional Application Ser. No. 60/732,905 filed Nov. 3, 2005, which application is hereby incorporated by reference to the same extent as though fully disclosed herein.

### FIELD OF THE INVENTION

The invention relates generally to the field of two-part connectors and hangers, in particular to such connectors and hangers which utilize a magnet in making the connection between the two parts.

### BACKGROUND OF THE INVENTION

Magnetic connectors are known in the art. See, for example, U.S. Pat. No. 6,499,437 issued Dec. 31, 2002 to Joseph A. Sorensen; U.S. Pat. No. 2,907,085 issued to J. M. Bosland on Oct. 6, 1959; and U.S. Pat. No. 2,496,691 issued to C. F. Berry on Feb. 7, 1950. Ball and socket type connectors are also well known. See, for example, U.S. Pat. No. 6,880,794 issued to Peter P. Kahn on Apr. 19, 2005; U.S. Pat. No. 4,067,532 issued to James F. Viteretto on Jan. 10, 1976; U.S. Pat. No. 3,176,951 issued to R. McFadyen et al. on Apr. 6, 1965; and U.S. Pat. No. 2,765,509 issued to Brehm on Oct. 9, 1956. All of these are either relatively complex designs and have a relatively narrow range of applications and cannot be released easily, or, if simple and easily released, can be released by normal human movement; thus, they are not useful, for example, for attaching a cell phone to a belt or a carabiner to a back pack. Thus, it would be highly desirable to have a connector system that can easily be connected and disconnected and yet remains securely connected when subjected to shocks such as generated by humans walking, running, or jumping.

### BRIEF SUMMARY OF THE INVENTION

The present invention solves the above problems, as well as other problems of the prior art, by providing a general purpose connector system in which almost any small object can be securely connected to another object and yet be manually released instantaneously when desired without using a tool. For example, a cell phone or music player can be securely connected to a belt without being disturbed by normal movements, and yet can instantly be removed when desired. One aspect which permits this is the combination of a head and socket with a magnetic connector.

The invention provides a general purpose releasable connector comprising: a first connector part comprising: a head and a first attachment member, a second connector part comprising: a socket for receiving the head and a second attachment member, and a first magnet embedded in one of either the first connector part or the second connector part, the other of the first connector part or the second connector part either having at least a portion that is ferromagnetic or including a second magnet, or both, whereby when the head is placed in the socket, the head is magnetically held in the socket. Preferably, the connector further includes a neck, the neck joining the head to the attachment member, the head having a width that is wider than the neck in at least one dimension; and wherein the socket has a first open end, a base, and a socket wall having opposing sides, the first open end being wider than the head and the base being sufficiently closed to support the head without the head passing through it, the opposing sides sloping inward from the first open end, the socket further including a slot passing through the socket wall, the slot being wider than the neck but narrower than the head. Preferably, the head is substantially ball shaped. Preferably, the first connector part includes a first flat surface and the second connector part includes a second flat surface that is positioned adjacent the first flat surface when the first connector part is connected to the second connector part, and the first magnet is embedded in either the first flat surface or the second flat surface. Preferably, the connector includes a second magnet and the second magnet is embedded in the other of the first flat surface and the second flat surface. Preferably, at least one of the flat surfaces comprises a surface of the magnet. Preferably, the connector further includes a lock for locking the first connector part to the second connector part. Preferably, the lock comprises a lock member pivotably coupled to the second connector part adjacent the slot. Preferably, either the first attachment member or the second attachment member comprises an attachment structure selected from the group consisting of: a webbing slot, a carabiner clip, a belt clip, a key ring, a flat surface suitable for attaching a double-sided sticker, and a through-hole. Preferably, the connector further includes a logo attachment structure. Preferably, the connector further includes a logo advertisement coupled to either the first connector part or the second connector part.

The invention also provides a method of connecting a first object to a second object, the method comprising: attaching the first object to a first connector part comprising a head; attaching the second object to a second connector part comprising a socket for receiving the head; placing the head in the socket; and magnetically coupling the first connector part to the second connector part. Preferably, the magnetically coupling comprises magnetically coupling a magnet in one of the first connector part and the second connector part to a ferromagnetic material in the other of the first connector part and the second connector part or magnetically coupling a first magnet in the first connector part to a second magnet in second connector part. Preferably, the magnets lie in parallel planes and the placing includes moving the head in a direction substantially parallel to the planes to lock the head into the socket. Preferably, one of the first object and the second object is a cell phone or a key ring, and the other of the first object and the second object is a belt or a strap. Preferably, the method further comprises integrally forming with the first connector part or the second connector part an attachment structure selected from the group consisting of: a webbing slot, a carabiner clip, a belt clip, a key ring, a flat surface suitable for attaching a double-sided sticker, and a through-hole. Preferably, the method further comprises attaching a logo to one of either the first connector part or the second connector part wherein the logo is selected from the group consisting of: of initials, a name, an emblem, or a picture. Preferably, the attaching the first object comprises attaching the first object to a first connector part comprising the head and a neck, the head having a width that is wider than the neck in at least one dimension; the attaching the second object comprises attaching the second object to a second connector part comprising the socket for receiving the head and a slot in the socket; and the placing further comprises passing the neck through the slot.

In another aspect, the invention provides a method of connecting a first object to a second object, the method comprising: attaching the first object to a first connector part including a head; attaching the second object to a second connector part comprising a socket adapted for receiving the head; placing the head near the socket; and automatically guiding the socket into a predetermined position in the socket using magnetism.

The invention provides an extremely flexible system that permits ease of connection and disconnection of almost any portal item to a pack, belt, or other human accouterment, yet the connection is not affected by even significant shocks such as caused by a person falling or jumping. Numerous other features, objects, and advantages of the invention will become apparent from the following description when read in conjunction with the accompanying drawings.

### BRIEF DESCRIPTION OF THE DRAWINGS

FIG. 1 is a perspective view of an exemplary embodiment of the invention;

FIG. 2 is a perspective view of another exemplary embodiment of the invention;

FIG. 3 is a plan view of another exemplary embodiment of the invention;

FIG. 4 is a cross-sectional view of the embodiment of FIG. 3 through the line 4-4 of FIG. 3;

FIG. 5 is plan view of an exemplary embodiment of another embodiment of a second connector member according to the invention;

FIG. 6 is a partial cross-section of the connector of FIG. 5 together with a side view of another embodiment of a first connector member according to the invention connected to a cell phone;

FIG. 7 is a plan view of another exemplary embodiment of the invention;

FIG. 8 is a cross-sectional view of the embodiment of FIG. 7 through the line 8-8 of FIG. 7;

FIGS. 9-11 illustrate yet another embodiment of the invention;

FIGS. 12-15 illustrate a number of ways to integrate various embodiments of the invention with various attachment structures; and

FIG. 16 illustrates one embodiment of the combination of a logo with a connector system according to the invention.

### DETAILED DESCRIPTION OF THE INVENTION

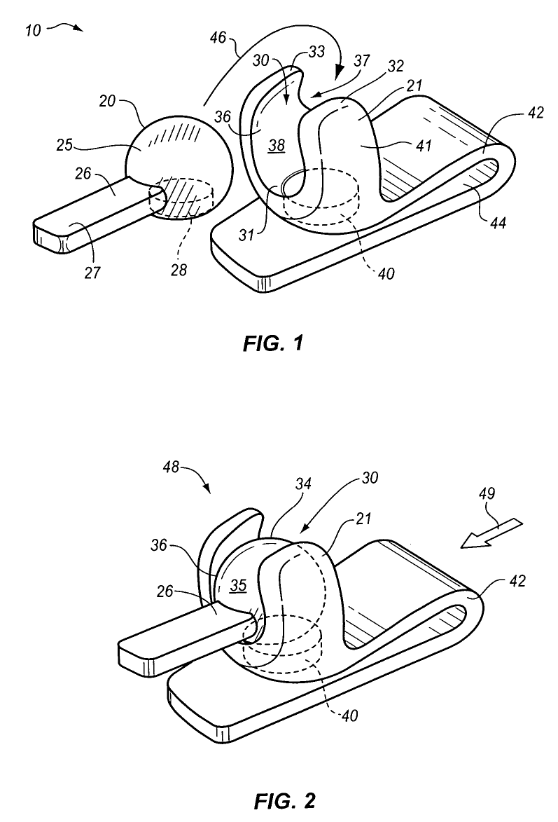

Referring to FIG. 1, an exemplary embodiment 10 of the invention is shown. The invention comprises a system 10 for releasably connecting two objects. A first connector part 20 is adapted to be attached to a first object and a second connector part 21 is adapted to be attached to a second object. When part 20 is placed appropriately adjacent part 21, as shown by arrow 46, magnetic attraction between the first connector part 20 and second connector part 21 causes them to attract and then connect automatically. A specialized head-and-socket configuration 25, 30, in combination with the magnetic force holds the first connector part 20 securely to the second connector part 21, yet permits it to be released quickly.

Turning now to the details of the embodiment shown in FIG. 1, first connecting part 20 includes a head 25, a neck 26, and a first attachment member 27. In this embodiment, neck 26 is the portion of attachment member 27 adjacent head 25. Head 25 is generally wider than neck 26 in at least one dimension; but in this embodiment, head 25 is a ball, and thus it is wider in two dimensions. A first magnet 28 is embedded in head 25. Second connecting part 21 comprises a socket 30 for receiving head 25 and second attachment member 42. Socket 30 has a first open end 37, a base 31, and a socket wall 41 with opposing sides 32 and 33. First open end 37 is wider than head 25, and base 31 is sufficiently closed to support head 25 without the head passing through it. In this embodiment, base 31 is completely closed; but in other embodiments, it may not be completely closed. Magnet 40 forms part of base 31 in this embodiment. Opposing sides 32 and 33 slope inward from first open end 37. A slot 36 is formed in socket wall 38. Slot 36 is wider than neck 26 but narrower than head 25. A first magnet 28 is embedded in head 25 and a second magnet 40 is embedded in base 31. When head 25 is placed in socket 30, head 25 is magnetically held in socket 30.

In the embodiment of FIG. 1, connecting parts 20 and 21 are preferably made of non-ferrous material such as molded plastic, aluminum, brass, etc., though they also may be made of a ferrous metal. The inner surface 38 of the socket wall 41 follows the curvature of ball 25 except that it is preferably slightly larger so that the ball can rotate in the socket, though the magnets are preferably strong enough so significant force is required to rotate the ball. This allows the relative positions of the objects attached to attachment members 27 and 42 to be rotatably adjusted and remain in place after the adjustment. The placement of the magnets 28 and 40 keeps the ball 25 centered in socket 37, and the fact that the diameter of ball 25 is larger than the width of slot 36 locks the ball firmly in the socket. That is, the upper tips of walls 32 and 33 curve inward and act as a lock to prevent the ball from being moved in a direction perpendicular to the parallel surfaces of magnets 28 and 40.

FIG. 2 shows another embodiment 48 of the invention. In this embodiment, second connector part 21 is identical to that of the embodiment of FIG. 1, but first connecting part 34 is made of ferrous material such as steel, iron, etc. Thus, a magnet is not necessary in first connecting part 34. When first connecting part 34 is brought into close proximity to second connecting part 21, magnet 40 attracts the ball 35, which then drops into the socket 30 as shown in FIG. 2. Since the ball 35 is the most massive portion of connecting part 34, it moves to a position opposite the center of the magnet. Thus, the ball is centered within the socket. In both the embodiment of FIG. 1 and the embodiment of FIG. 2, neck 26 lies within slot 36, thus maintaining a low profile. To engage the two connector parts, connector part 34 is moved in the direction 49 to lock the ball 35 under the upper ends of walls 32 and 33. To release the connector system 10, 48, second connector part 21 is moved in direction 49 with respect to first connector parts 20, 34, which disengages the magnet from the ball and also disengages the ball from the socket.

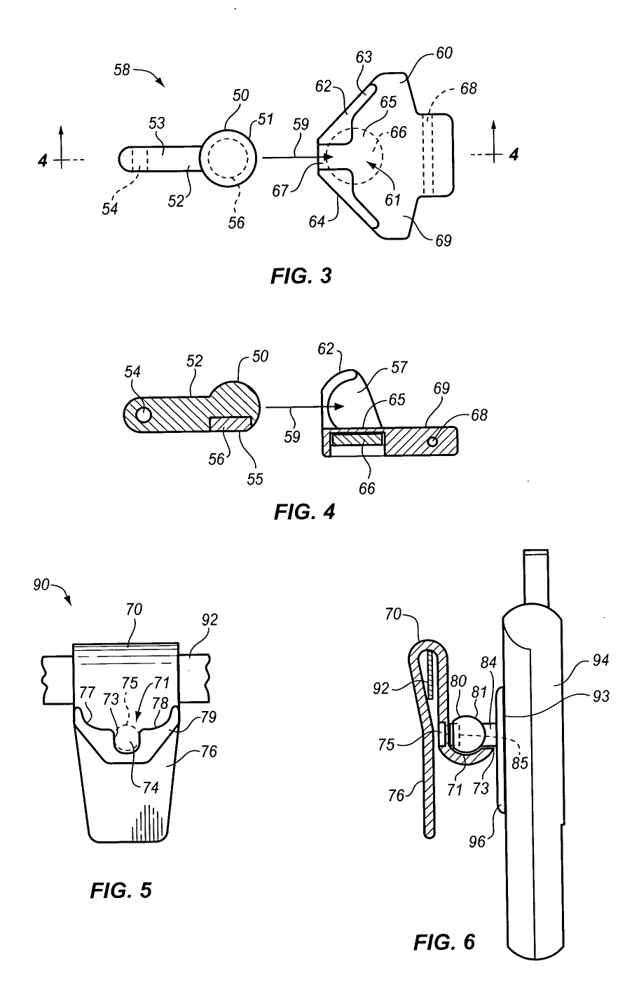

FIGS. 3 and 4 show another embodiment of the subject invention. System 58 includes first connector part 50 and second connector part 60. First connector part 50 includes head 51, neck 52, and attachment member 53 with attachment structure 54, which, in this embodiment, is a hole through attachment member 53. A magnet 56 is embedded in head 51. Second connector part 60 includes socket 61 having a socket wall 63 divided into a first wall portion 62 and a second wall portion 64 by slot 67, attachment member 69 having an attachment structure 68, which, in this embodiment is a bore 68, and magnet 66. In this case, the ball has been truncated to produce a flat surface 55 at the bottom, which preferably corresponds to the bottom of magnet 56. Surface 55 helps the user distinguish the top of connector part 50 from the bottom, and also causes connector part 50 to lie flat against the base 65 with second connector part 60 when they are connected, giving magnets 56 and 66 increased holding power, since they now act against a flat surface rather than a radius. If connector part 50 is upside-down, the magnets 56 and 66 will repel each other. If connector part 50 is right-side up, they will attract. Therefore, this embodiment orients connector parts 50 and 60 automatically. In this embodiment, the connector parts 50 and 60 are preferably made of a non-ferrous material, though they also could be made of a ferrous material. Socket wall 63 is preferably ball-shaped to conform to the surface of ball 51. As can best be seen in FIG. 4, the upper portion of walls 62 and 63 forms a lip that prevents movement of the head 51 in a direction perpendicular to the parallel surfaces 55 and 65. When connector part 50 is moved in a direction parallel to the surfaces 55 and 65, opposite to the direction of arrow 59, connector part is locked in place by shaped surface 57. The combination of this shaped surface 57 and magnets 56 and 66 with flat surfaces 55 and 65 keeps connector part 50 firmly attached to connector part 60 once they are connected, but also allows them to be released without significant force if the connector 50 is pushed in the direction of arrow 59.

FIGS. 5 and 6 illustrate yet another embodiment 90 of the subject invention, showing a way of releasably attaching an electronic device 94 to a clip 76. Preferably, the electronic device is a cell phone, but also may be a Blue Tooth™ device, a music electronic device, or other electronic device. Connector part 70 comprises socket 71, a magnet 75, the top of which forms a base 74, and an attachment member 76. Socket 71 has socket wall 79 divided into a first socket wall portion 77 and a second socket wall portion 78 by slot 73. Connector part 70 includes a head 81, a neck 84, an optional magnet 85, and an attachment member 96 having an attachment structure 93 comprising a flat surface having a two-sided sticky tape 93 for attaching cell phone 94. In FIGS. 5 and 6, clip 76 is shown clipped to a belt 92. In the preferred embodiment, magnet 85 is not used, connector part 70 is preferably made of a non-ferrous material, and connector part 80 is made of a ferrous material. This embodiment allows the cell phone to automatically attach to the belt clip, and yet rotate freely to a comfortable position while still attached. Since connector part 80 is made of ferrous material, it attracts to magnet 75 and automatically connects parts 70 and 80, yet shields the cell phone 94 from magnetic field interference from the magnet 75.

In an alternative embodiment, part 80 includes magnet 85 embedded in head 81, and both parts 70 and 80 are preferably made of a non-ferrous material. This embodiment keeps the cell phone 94 more rigidly in a preferred position determined by the placement of magnets 75 and 85. Attachment member 96 may be made of a ferrous material to shield cell phone 94 from any magnetic effect of magnets 75 and 85, though, because they have opposite poles, the magnetic field of the magnets is very compact and does not appreciably extend out to cell phone 94.

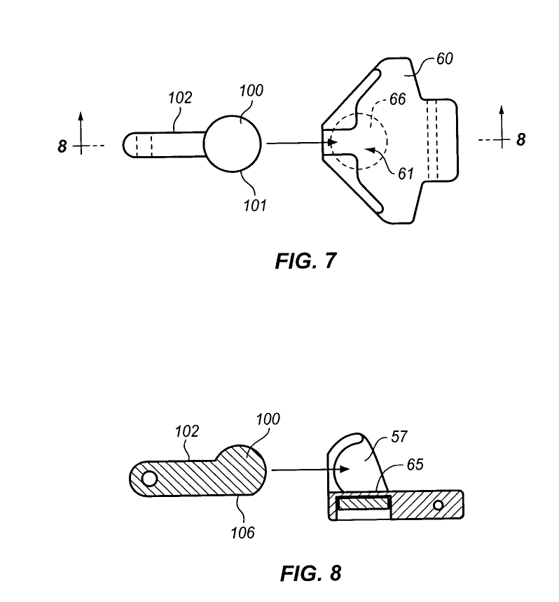

FIGS. 7 and 8 illustrate an embodiment of the invention that is identical to the embodiment of FIGS. 3 and 4 except that there is no magnet embedded in first connector part 100. Since ball 101 is the most massive portion of connecting part 100, it moves to a position opposite the center of magnet 66. Thus, ball 101 is centered within socket 61. However, the absence of a second magnet permits ball 101 to be moved somewhat more freely in socket 61, though flat surfaces 106 and 65 tend to cause it to return when moved.

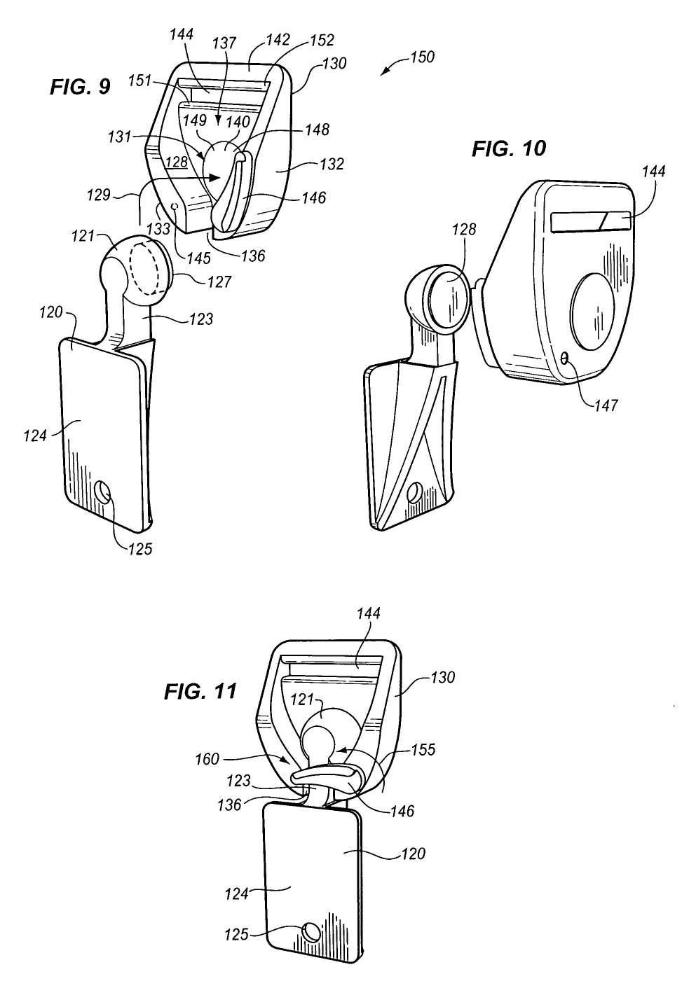

FIGS. 9, 10, and 11 illustrate another embodiment of the invention. System 150 includes first connector member 120 and second connector member 130. First connector member 120 comprises head 121, neck 123, attachment member 124, and magnet 127. In this embodiment, attachment member 124 includes an attachment structure including a flat surface 124 and a through-hole 125. Surface 124 is offset from head 121 in a direction away from the flat surface 128 of magnet 127. Second connector member 130 comprises socket 131, formed by socket wall 138 and base 148, and second attachment member 142. Socket 131 has first open end 137, and socket wall 128 is divided into opposing sides 132 and 133 by slot 136. The inner surfaces of sides 132 and 133 slope inward from first open end 137 toward slot 136. Second connector 130 also includes magnet 140, the upper surface 149 of which forms part of base 148. Second attachment member 142 includes attachment structure 144, which, in this embodiment, is a slot 144 for attaching a strap, preferably made of webbing. The edges 151 and 152 of slot 144 are tapered and/or serrated to better hold the strap. System 150 also includes a lock 160 for locking first connector member 120 to second connector member 130. In this embodiment, lock 160 includes a locking arm 146, a pivot pin 147 (FIG. 10) and a detent 145 (FIG. 9), but may comprise other suitable structures. The width of head 121 in the direction parallel to the flat surface 149 of base 148 is wider than the width of neck 123 in the same direction. Slot 136 is just slightly wider than neck 123 and much narrower than head 121. In this embodiment, connectors 120 and 130 are preferably made of a non-ferrous material.

First connector 120 is connected to second connector 130 bypassing neck 123 through slot 136 and placing head 121 in the vicinity of socket 131, as indicted by arrow 129. The sloping sides of wall 138 and magnets 127 and 140, as well as flat surfaces 128 and 149, cause head 121 to automatically move to the bottom of socket 131. Lock arm 146 is then pivoted in the direction of arrow 155 (FIG. 11) to close slot 136. Detent 145 resists the opening of arm 146.

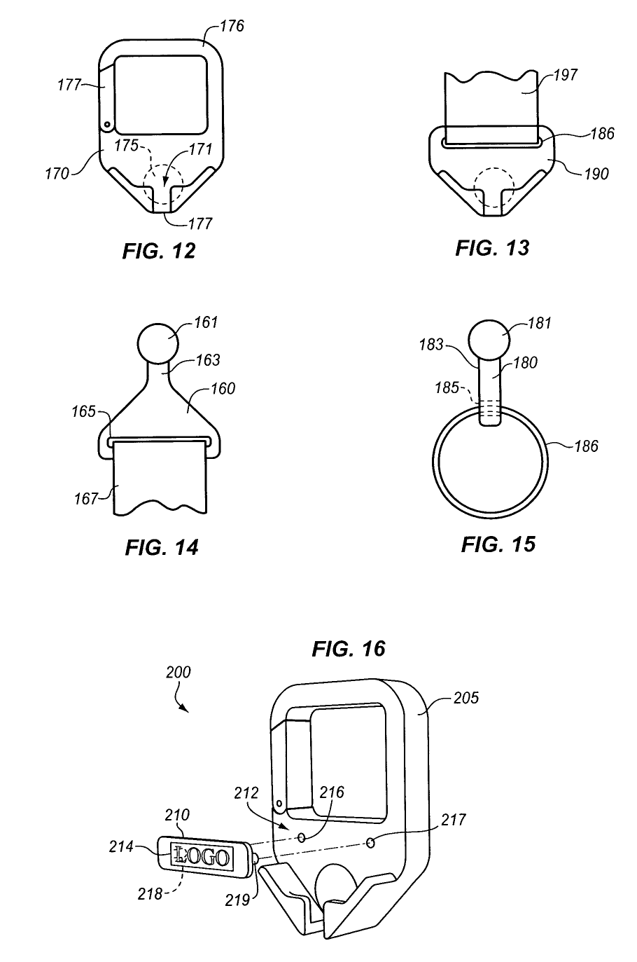

FIGS. 12-14 illustrate a number of ways to integrate the subject invention with various attachment structures. In FIG. 12, a connector 170 having a socket 171 of the type shown in FIGS. 3 and 4 and a magnet 175 is integrally formed with a carabiner-style clip 156 with a carabiner-style gate member 177. In FIG. 13, this same style of connecting member 190 is integrally formed with a slot 186 suitable for connecting to a strap 197, preferably one made of webbing.

In FIG. 14, a first connector 160 having a head 161 and a neck 163 is integrally formed with a slot 165. In FIG. 15, a first connector 180 having head 181 and neck 183 is integrally formed with attachment structure 185 comprising through-hole 185 to which is connected a key ring 186.

Connector 160 can be mated with connector 170 to releasably connect a carabiner to a strap of a pack or to connector 190 to releasably connect two straps. Connector 180 can be mated with connector 170 to releasably connect a ring to a carabiner or to connector 190 to connect a ring to a strap. These are merely exemplary. Any attachment structure discussed above, or any other attachment structures known in the art, may be integrally formed with any of the connectors discussed above. The connector pairs may include two magnets as shown in some embodiments above, or a connector with a magnet and a ferrous metal connector as shown in other embodiments above.

FIG. 16 shows a system 200 including a connector 205 having a logo attachment structure 212 to which is attached a logo 214. Logo attachment structure 212 includes a pair of holes 216 and 217 which mate with a pair of pins 218 and 219 integrally formed with logo plate 210. The logo attachment structure can be formed in any of the connectors discussed above and the logo attached. With the logo, the invention can become a relatively inexpensive but useful and interesting give-away for advertising purposes. The logo can also be in the form of initials, a name, an emblem, or a picture to make a personalized connector which makes an interesting and useful gift item.

There has been described a general purpose releasable connector system. It should be understood that the particular embodiments shown in the drawings and described within this specification are for purposes of example and should not be construed to limit the invention, which will be described in the claims below. Further, it is evident that those skilled in the art may now make numerous uses and modifications of the specific embodiment described, without departing from the inventive concepts. For example, the necks could be bent at ninety degrees and the slot eliminated so long as the magnet/ferrous material position was appropriately changed so they were opposing on the two connector parts. Or the necks could be eliminated entirely so long as there is a head and a socket to receive it, and opposing magnets/ferrous structures formed in the two connector parts. Equivalent structures and processes may be substituted for the various structures and processes described; the subprocesses of the inventive method may, in some instances, be performed in a different order, or a variety of different materials and elements may be used. Consequently, the invention is to be construed as embracing each and every novel feature and novel combination of features present in and/or possessed by the general purpose releasable connector system and methods described.

What is claimed as new and desired to be protected by Letters Patent of the United States is:

1. A general purpose releasable connector comprising:
a first connector part comprising: a head and a first attachment member;
a second connector part comprising: a socket for receiving said head and a second attachment member; and
a first magnet embedded in one of either said first connector part or said second connector part, the other of said first connector part or said second connector part either having at least a portion that is ferromagnetic or including a second magnet, or both, whereby when said head is placed in said socket, said head is magnetically held in said socket.

2. A general purpose connector as in claim 1 and further including a neck, said neck joining said head to said attachment member, said head having a width that is wider than said neck in at least one dimension; and wherein said socket has a first open end, a base, and a socket wall having opposing sides, said first open end being wider than said head and said base being sufficiently closed to support said head without said head passing through it, said opposing sides sloping inward from said first open end, said socket further including a slot passing through said socket wall, said slot being wider than said neck but narrower than said head.

3. A general purpose connector as in claim 1 wherein said head is substantially ball shaped.

4. A general purpose connector as in claim 1 wherein said first connector part includes a first flat surface and said second connector part includes a second flat surface that is positioned adjacent said first flat surface when said first connector part is connected to said second connector part, and said first magnet is embedded in either said first flat surface or said second flat surface.

5. A general purpose connector as in claim 4 wherein said connector includes a second magnet and said second magnet is embedded in the other of said first flat surface and said second flat surface.

6. A general purpose connector as in claim 4 wherein at least one of said flat surfaces comprises a surface of said magnet.

7. A general purpose connector as in claim 1 and further including a lock for locking said first connector part to said second connector part.

8. A general purpose connector as in claim 6 wherein said lock comprises a lock member pivotably coupled to said second connector part adjacent said slot.

9. A general purpose connector as in claim 1 wherein either said first attachment member or said second attachment member comprises an attachment structure selected from the group consisting of: a webbing slot, a carabiner clip, a belt clip, a key ring, a flat surface suitable for attaching a double-sided sticker, and a through-hole.

10. A general purpose connector as in claim 1 and further including a logo attachment structure.

11. A general purpose connector as in claim 10 and further including a logo advertisement coupled to either said first connector part or said second connector part.

12. A method of connecting a first object to a second object, said method comprising:
attaching said first object to a first connector part comprising a head;
attaching said second object to a second connector part comprising a socket for receiving said head;
placing said head in said socket; and
magnetically coupling said first connector part to said second connector part.

13. A method as in claim 12 wherein said magnetically coupling comprises magnetically coupling a magnet in one of said first connector part and said second connector part to a ferromagnetic material in said other of said first connector part and said second connector part.

14. A method as in claim 12 wherein said magnetically coupling comprises magnetically coupling a first magnet in said first connector part to a second magnet in second connector part.

15. A method as in claim 14 wherein said magnets lie in parallel planes and said placing includes moving said head in a direction substantially parallel to said planes to lock said head into said socket.

16. A method as in claim 12 wherein one of said first object and said second object is a cell phone or a key ring, and the other of said first object and said second object is a belt or a strap.

17. A method as in claim 12 and further comprising integrally forming with said first connector part or said second connector part an attachment structure selected from the group consisting of: a webbing slot, a carabiner clip, a belt clip, a key ring, a flat surface suitable for attaching a double-sided sticker, and a through-hole.

18. A method as in claim 12 and further comprising attaching a logo to one of either said first connector part or said second connector part wherein said logo is selected from the group consisting of: of initials, a name, an emblem, or a picture.

19. A method as in claim 12 wherein:
said attaching said first object comprises attaching said first object to a first connector part comprising said head and a neck said head having a width that is wider than said neck in at least one dimension;
said attaching said second object comprises attaching said second object to a second connector part comprising said socket for receiving said head and a slot in said socket; and
said placing further comprises passing said neck through said slot.

20. A method of connecting a first object to a second object, said method comprising:
attaching said first object to a first connector part including a head;
attaching said second object to a second connector part comprising a socket adapted for receiving said head;
placing said head near said socket; and
automatically guiding said socket into a predetermined position in said socket using magnetism.
